(19) United States
(12) Patent Application Publication
(10) Pub. No.: US 2007/0037733 A1
(43) Pub. Date: Feb. 15, 2007

(54) Use of 3-cyclohexenyl-1-propanol as a fragrance

(76) Inventors: Johannes Panten, Hoxter (DE); Thomas Obrocki, Pattensen (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/573,451

(22) PCT Filed: Sep. 21, 2004
(86) PCT No.: PCT/EP04/52261

§ 371 Date: Mar. 24, 2006

(30) Foreign Application Priority Data
Sep. 26, 2003 (DE) 103 44 899.3

(51) Int. Cl. A61Q 13/00

(52) U.S. Cl. 512/1

(57) ABSTRACT

The invention relates to a novel use of 3-cyclohexenyl-1-propanol, to fragrance compositions and perfumed articles comprising the compound, and to a process for the preparation of a fragrance composition comprising the compound.

The present invention relates to a novel use of 3-cyclohexenyl-1-propanol, to fragrance compositions and perfumed articles comprising the compound, and to a process for the preparation of a fragrance composition comprising the compound.

Despite the existence of a large number of fragrances, there is a continued general need in the perfume industry for novel fragrances which, in addition to their primary, namely odour-related properties, possess additional positive secondary properties, such as, for example, greater stability under particular use conditions, greater strength, better adhering power and also better dermatological and toxicological results compared with comparable fragrances.

Just recently, misgivings about some frequently used fragrances have increasingly been expressed in respect of the last-mentioned properties. It is expected that their use will be limited in the future or will have to be stopped altogether. An example of such a fragrance is cinnamaldehyde which, as its name suggests, is distinguished by its pronounced cinnamon odour.

There is therefore a need in the perfume industry for further fragrances which are suitable for the preparation of fragrance compositions or perfumed articles. In particular, there is a need for fragrances having a cinnamon character which are capable of producing a cinnamon-like odour note in fragrance compositions, in particular perfume compositions. In particular, the fragrances should not have any negative toxicological properties.

According to the invention, this object is achieved by the use in accordance with the invention according to claim 1, by the fragrance composition or perfumed article according to claim 4 and by the process for the preparation of a fragrance composition according to claim 8.

The invention is based inter alia on the surprising finding that the compound 3-cyclohexenyl-1-propanol is suitable as a fragrance. The fragrance can be in the form of the enantiomer having the R configuration, the enantiomer having the S configuration or any desired mixture of the two enantiomers, in particular in the form of a racemate.

The structural formula of 3-cyclohexenyl-1-propanol (IUPAC: cyclohex-3-enylpropan-1-ol) is shown below:

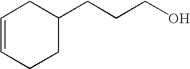

The compound is known per se from the literature:

J. Org. Chem. 1968, 33(7), 2991-2993 describes the synthesis of 3-cyclohexenyl-1-propanol starting from 3-cyclohexenylcarbinyl chloride by Grignard reaction with ethylene oxide.

In Synthesis 1976, 6, 391-393, a novel synthesis of primary alcohols with activation of a cyano group is described with reference to the example of 3-cyclohexenyl-1-propanol inter alia.

J. Chem. Soc., Chem. Commun. 1991, 4, 233-234 reports a novel synthesis of 3-cyclohexenyl-1-propanol by reductive carbonylation of alkenes using zwitterionic rhodium complexes as catalysts.

There is no mention in any of the publications of the olfactory properties of 3-cyclohexenyl-1-propanol.

It has now been found that 3-cyclohexenyl-1-propanol is outstandingly suitable for imparting, modifying and/or enhancing an odour having one or more of the notes hydrocinnamic alcohol-like, mushroom-like, hay-like, cinnamon-like, balsamic, flowery and/or an after-odour having one or more of the notes rosy, fruity, damascenone-like.

3-Cyclohexenyl-1-propanol is particularly suitable for imparting, modifying and/or enhancing a cinnamon-like odour note. The fact that this compound exhibits a pronounced cinnamon-like odour is particularly surprising because it is not—like the common fragrances having a cinnamon-like odour note—an aromatic aldehyde but an alicyclic alcohol. Usually, a change in functionalities leads to markedly different olfactory properties even in otherwise structurally similar compounds. Table 1 below shows examples of selected scent descriptions for structurally similar alicyclic alcohols and known aldehydes (source: S. Arctander, Perfume and Flavor Chemicals, Vol. 1 and 11, Montclair, N.J., 1969, published by the author, or K. Bauer, D. Garbe and H. Surburg, Common Fragrance and Flavor Materials, 4^{rd}. Ed., Wiley-VCH, Weinheim 2001). As will be seen, none of the alcohols exhibits a cinnamon-like odour note. By contrast, such an odour note is typical of aromatic aldehydes. Accordingly, it was particularly surprising that the alcohol according to the invention exhibits a cinnamon-like odour note.

TABLE 1

| Name | Structure | Description of odour |
|---|---|---|
| Cinnamic alcohol | 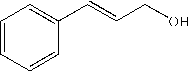 | sweet, balsamic, flowery, hyacinths, rose aspects |
| Dihydrocinnamic alcohol | 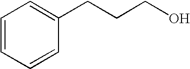 | sweet, balsamic, hyacinths, flowery, warm and mild |
| Cyclohexyl propanol | 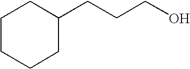 | very mild, sweet, balsamic, flowery, less flowery than hydrocinnamic alcohol, no rose aspects |
| Dihydrocinnamaldehyde | 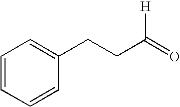 | hyacinths, earthy, warm, cherries, cinnamon, plums |
| Cinnamaldehyde | 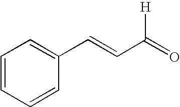 | cinnamon, spicy, aromatic, clove, sweet, cassia |
| Cyclohexenylpropanol | 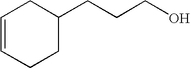 | hydrocinnamic alcohol, mushroom- like, hay, balsamic, rosalva, rosy, phenylethyl alcohol, cinnamon, styrax, sweet, flowery |

According to the invention, a fragrance composition or a perfumed article also comprises 3-cyclohexenyl-1-propanol. The olfactory properties, material properties, such as solubility in conventional cosmetic solvents, compatibility with conventional further constituents of such products, etc., and the toxicological harmlessness of the compound underline the particular suitability of the compound for the mentioned uses.

Particular preference is given to fragrance compositions or perfumed articles comprising an amount of 3-cyclohexenyl-1-propanol that is sufficient to impart, modify and/or enhance a cinnamon-like odour note.

It is further preferred for an amount of 3-cyclohexenyl-1-propanol to be present in fragrance compositions or perfumed articles that is sufficient to impart, modify and/or enhance one or more of the odour notes hydrocinnamic alcohol-like, mushroom-like, hay-like, cinnamon-like, balsamic, flowery and/or one or more of the after-notes rosy, fruity, damascenone-like.

According to the invention, a fragrance composition is prepared by mixing 3-cyclohexenyl-1-propanol with conventional further constituents of a fragrance composition, the 3-cyclohexenyl-1-propanol being used in an amount that is sufficient to impart, modify and/or enhance an odour note in the fragrance composition. Cinnamon-like odour notes are used in particular in a wide variety of perfume compositions, for example also in floral scent themes. The example given hereinbelow of a “white blossom” scent theme clearly demonstrates the olfactory effect of 3-cyclohexenyl-1-propanol.

On account of its olfactory properties, 3-cyclohexenyl-1-propanol is excellently suitable for use in perfume compositions. The compound can be used in many products in the form of a single substance or combined with a large number of other fragrances. It is particularly advantageous to combine the compound with other fragrances in various different ratios to form novel perfume compositions.

Examples of fragrances with which the alcohol according to the invention can advantageously be combined are to be found, for example, in S. Arctander, Perfume and Flavor Chemicals, Vol. I and II, Montclair, N.J., 1969, published by the author, or K. Bauer, D. Garbe and H. Surburg, Common Fragrance and Flavor Materials, 4rd. Ed., Wiley-VCH, Weinheim 2001. The following may be mentioned specifically: extracts from natural raw materials such as essential oils, concretes, absolutes, resins, resinoids, balsams, tinctures, such as, for example,

amber tincture; amyris oil; angelica seed oil; angelica root oil; aniseed oil; valerian oil; basil oil; tree moss absolute; bay oil; artemisia oil; benzoin resin; bergamot oil; beeswax absolute; birch tar oil; bitter almond oil; summer savory oil; buchu oil; cabreuva oil; oil of cade; oil of calamus; camphor oil; cananga oil; cardamom oil; cascarilla oil; oil of cassia; cassia absolute; castoreum absolute; cedar leaf oil; cedarwood oil; cistus oil; citronella oil; lemon oil; copaiva balsam; copaiva balsam oil; coriander oil; costus root oil; cumin oil; cypress oil; davana oil; dill oil; dill seed oil; eau de brouts absolute; oak moss absolute; elemi oil; tarragon oil; Eucalyptus citriodora oil; eucalyptus oil; fennel oil; spruce-needle oil; galbanum oil; galbanum resin; geranium oil; grapefruit oil; guaiacwood oil; gurjun balsam; gurjun balsam oil; helichrysum absolute; helichrysum oil; ginger oil; orris root absolute; orris root oil; jasmine absolute; calamus oil; blue camomile oil; Roman camomile oil; carrot seed oil; cascarilla oil; pine-needle oil; spearmint oil; caraway oil; labdanum oil; labdanum absolute; labdanum resin; lavandin absolute; lavandin oil; lavender absolute; lavender oil; lemongrass oil; lovage oil; lime oil; lime oil distilled; lime oil pressed; linaloa oil; litseacubeba oil; oil of laurel leaves; oil of mace; marjoram oil; mandarin oil; massoia bark oil; mimosa absolute; musk seed oil; musk tincture; oil of clary sage; nutmeg oil; myrrh absolute; myrrh oil; myrtle oil; clove leaf oil; clove flower oil; Neroli oil; olibanum absolute; olibanum oil; opopanax oil; orange blossom absolute; orange oil; origanum oil; palmarosa oil; patchouli oil; perilla oil; Peru balsam oil; parsley leaf oil; parsley seed oil; oil of petitgrain; peppermint oil; pepper oil; pimento oil; pine oil; poley oil; rose absolute; rosewood oil; rose oil; rosemary oil; oil of Dalmatian sage; oil of Spanish sage; sandalwood oil; celery seed oil; spike oil; star anise oil; styrax oil; tagetes oil; fir-needle oil; tea tree oil; terpentine oil; thyme oil; tolu balsam; tonka absolute; tuberose absolute; vanilla extract; violet leaf absolute; verbena oil; vetiver oil; oil of juniper berries; grapeseed oil; vermouth oil; oil of wintergreen; ylang oil; oil of hyssop; civet absolute; cinnamon leaf oil; cinnamon bark oil as well as fractions thereof, or ingredients isolated therefrom;

individual fragrances from the group of the hydrocarbons, such as, for example, 3-carene; α-pinene; β-pinene; α-terpinene; γ-terpinene; p-cymene; bisabolene; camphene; caryophyllene; cedrene; farnesene; limonene; longifolene; myrcene; ocimene; valencene; (E,Z)-1,3,5-undecatriene; styrene; diphenylmethane;

of the alihpatic alcohols, such as, for example, hexanol; octanol; 3-octanol; 2,6-dimethylheptanol; 2-methyl-2-heptanol; 2-methyl-2-octanol; (E)-2-hexenol; (E)- and (Z)-3-hexenol; 1-octen-3-ol; mixture of 3,4,5,6,6-pentamethyl-3/4-hepten-2-ol and 3,5,6,6-tetramethyl-4-methyleneheptan-2-ol; (E,Z)-2,6-nonadienol; 3,7-dimethyl-7-methoxyoctan-2-ol; 9-decenol; 10-undecenol; 4-methyl-3-decen-5-ol;

of the aliphatic aldehydes and their acetals, such as, for example, hexanal; heptanal; octanal; nonanal; decanal; undecanal; dodecanal; tridecanal; 2-methyloctanal; 2-methylnonanal; (E)-2-hexenal; (Z)-4-heptenal; 2,6-dimethyl-5-heptenal; 10-undecenal; (E)-4-decenal; 2-dodecenal; 2,6,10-trimethyl-9-undecenal; 2,6,10-trimethyl-5,9-undecadienal; heptanaldiethylacetal; 1,1-dimethoxy-2,2,5-trimethyl-4-hexene; citronellyloxyacetaldehyde; 1-(1-methoxy-propoxy)-(E/Z)-3-hexene;

of the aliphatic ketones and their oximes, such as, for example, 2-heptanone; 2-octanone; 3-octanone; 2-nonanone; 5-methyl-3-heptanone; 5-methyl-3-heptanoneoxime; 2,4,4,7-tetramethyl-6-octen-3-one; 6-methyl-5-hepten-2-one;

of the aliphatic sulfur-containing compounds, such as, for example, 3-methylthio-hexanol; 3-methylthiohexyl acetate; 3-mercaptohexanol; 3-mercaptohexyl acetate; 3-mercaptohexyl butyrate; 3-acetylthiohexyl acetate; 1-menthene-8-thiol;

of the aliphatic nitriles, such as, for example, 2-nonenoic acid nitrile; 2-undecenoic acid nitrile; 2-tridecenoic acid nitrile; 3,12-tridecadienoic acid nitrile; 3,7-dimethyl-2,6-octadienoic acid nitrile; 3,7-dimethyl-6-octenoic acid nitrile;

of the esters of aliphatic carboxylic acids, such as, for example, (E)- and (Z)-3-hexenyl formate; ethyl acetoacetate; isoamyl acetate; hexyl acetate; 3,5,5-trimethylhexyl acetate; 3-methyl-2-butenyl acetate; (E)-2-hexenyl acetate; (E)- and (Z)-3-hexenyl acetate; octyl acetate; 3-octyl acetate; 1-octen-3-yl acetate; ethyl butyrate; butyl butyrate; isoamyl butyrate; hexyl butyrate; (E)- and (Z)-3-hexenyl isobutyrate; hexyl crotonate; ethyl isovalerate; ethyl-2-methyl pentanoate; ethyl hexanoate; allyl hexanoate; ethyl heptanoate; allyl heptanoate; ethyl octanoate; ethyl (E,Z)-2,4-decadienoate; methyl 2-octinate; methyl 2-noninate; allyl 2-isoamyloxyacetate; methyl 3,7-dimethyl-2,6-octadienoate; 4-methyl-2-pentyl crotonate;

of the acyclic terpene alcohols, such as, for example, citronellol; geraniol; nerol; linalool; lavandulol; nerolidol; farnesol; tetrahydrolinalool; tetrahydrogeraniol; 2,6-dimethyl-7-octen-2-ol; 2,6-dimethyloctan-2-ol; 2-methyl-6-methylene-7-octen-2-ol; 2,6-dimethyl-5,7-octadien-2-ol; 2,6-dimethyl-3,5-octadien-2-ol; 3,7-dimethyl-4,6-octadien-3-ol; 3,7-dimethyl-1,5,7-octatrien-3-ol 2,6-dimethyl-2,5,7-octatrien-1-ol; and their formates, acetates, propionates, isobutyrates, butyrates, isovalerates, pentanoates, hexanoates, crotonates, tiglinates and 3-methyl-2-butenoates;

of the acyclic terpenealdehydes and ketones, such as, for example, geranial; neral; citronellal; 7-hydroxy-3,7-dimethyloctanal; 7-methoxy-3,7-dimethyloctanal; 2,6,10-trimethyl-9-undecenal; geranylacetone; and the dimethyl- and diethyl-acetals of geranial, neral, 7-hydroxy-3,7-dimethyloctanal;

of the cyclic terpene alcohols, such as, for example, menthol; isopulegol; alpha-terpineol; terpinenol-4; menthan-8-ol; menthan-1-ol; menthan-7-ol; borneol; isoborneol; linalool oxide; nopol; cedrol; ambrinol; vetiverol; guaiol; and their formates, acetates, propionates, isobutyrates, butyrates, isovalerates, pentanoates, hexanoates, crotonates, tiglinates and 3-methyl-2-butenoates;

of the cyclic terpenealdehydes and ketones, such as, for example, menthone; isomenthone; 8-mercaptomenthan-3-one; carvone; camphor; fenchone; alpha-ionone; beta-ionone; alpha-n-methylionone; beta-n-methylionone; alpha-isomethylionone; beta-isomethylionone; alpha-irone; alpha-damascone; beta-damascone; beta-damascenone; delta-damascone; gamma-damascone; 1-(2,4,4-trimethyl-2-cyclohexen-1-yl)-2-buten-1-one; 1,3,4,6,7,8a-hexahydro-1,1,5,5-tetramethyl-2H-2,4a-methanonaphthalen-8(5H)-one; 2-methyl-4-(2,6,6-trimethyl-1-cyclohexen-1-yl)-2-butenal; nootcatone; dihydronootcatone; 4,6,8-megastigmatrien-3-one; alpha-sinensal; beta-sinensal; acetylated cedar wood oil (methyl cedryl ketone);

of the cyclic alcohols, such as, for example, 4-tert.-butylcyclohexanol; 3,3,5-trimethylcyclohexanol; 3-isocamphylcyclohexanol; 2,6,9-trimethyl-Z2,Z5, E9-cyclododecatrien-1-ol; 2-isobutyl-4-methyltetrahydro-2H-pyran-4-ol;

of the cycloaliphatic alcohols, such as, for example, alpha-3,3-trimethylcyclohexylmethanol;1-(4-isopropylcyclohexyl)ethanol; 2-methyl-4-(2,2,3-trimethyl-3-cyclopent-1-yl)butanol; 2-methyl-4-(2,2,3-trimethyl-3-cyclopent-1-yl)-2-buten-1-ol; 2-ethyl-4-(2,2,3-trimethyl-3-cyclopent-1-yl)-2-buten-1-ol; 3-methyl-5-(2,2,3-trimethyl-3-cyclopent-1-yl)-pentan-2-ol; 3-methyl-5-(2,2,3-trimethyl-3-cyclopent-1-yl)-4-penten-2-ol; 3,3-dimethyl-5-(2,2,3-trimethyl-3-cyclopent-1-yl)-4-penten-2-ol; 1-(2,2,6-trimethylcyclo-hexyl)pentan-3-ol; 1-(2,2,6-trimethylcyclohexyl)hexan-3-ol;

of the cyclic and cycloaliphatic ethers, such as, for example, cineol; cedryl methyl ether; cyclododecyl methyl ether; 1,1-dimethoxycyclododecane; (ethoxymethoxy)cyclododecane; alpha-cedrene epoxide; 3a,6,6,9a-tetramethyldodecahydronaphtho[2,1-b]furan; 3a-ethyl-6,6,9a-trimethyldodecahydronaphtho[2,1-b]furan; 1,5,9-trimethyl-13-oxabicyclo[10.1.0]trideca-4,8-diene; rose oxide; 2-(2,4-dimethyl-3-cyclohexen-1-yl)-5-methyl-5-(1-methylpropyl)-1,3-dioxane;

of the cyclic and macrocyclic ketones, such as, for example, 4-tert.-butylcyclohexanone; 2,2,5-trimethyl-5-pentylcyclopentanone; 2-heptylcyclopentanone; 2-pentylcyclopentanone; 2-hydroxy-3-methyl-2-cyclopenten-1-one; 3-methyl-cis-2-penten-1-yl-2-cyclopenten-1-one; 3-methyl-2-pentyl-2-cyclopenten-1-one; 3-methyl-4-cyclopentadecenone; 3-methyl-5-cyclopentadecenone; 3-methylcyclopentadecanone; 4-(1-ethoxyvinyl)-3,3,5,5-tetramethylcyclohexanone; 4-tert.-pentylcyclohexanone; 5-cyclohexadecen-1-one; 6,7-dihydro-1,1,2,3,3-pentamethyl-4(5H)-indanone; 8-cyclohexadecen-1-one; 9-cycloheptadecen-1-one; cyclopentadecanone; cyclohexadecanone;

of the cycloaliphatic aldehydes, such as, for example, 2,4-dimethyl-3-cyclohexenecarbaldehyde; 2-methyl-4-(2,2,6-trimethyl-cyclohexen-1-yl)-2-butenal; 4-(4-hydroxy-4-methylpentyl)-3-cyclohexenecarbaldehyde; 4-(4-methyl-3-penten-1-yl)-3-cyclohexenecarbaldehyde;

of the cycloaliphatic ketones, such as, for example, 1-(3,3-dimethylcyclohexyl)-4-penten-1-one; 2,2-dimethyl-1-(2,4-dimethyl-3-cyclohexen-1-yl)-1-propanone; 1-(5,5-dimethyl-1-cyclohexen-1-yl)-4-penten-1-one; 2,3,8,8-tetramethyl-1,2,3,4,5,6,7,8-octahydro-2-naphthalenyl methyl ketone; methyl 2,6,10-trimethyl-2,5,9-cyclododecatrienyl ketone; tert.-butyl (2,4-dimethyl-3-cyclohexen-1-yl) ketone;

of the esters of cyclic alcohols, such as, for example, 2-tert-butyl cyclohexylacetate; 4-tert-butyl cyclohexylacetate; 2-tert-pentyl cyclohexylacetate; 4-tert-pentyl cyclohexylacetate; 3,3,5-trimethyl cyclohexylacetate; decahydro-2-naphthyl acetate; 2-cyclopentyl cyclopentylcrotonate; 3-pentyltetrahydro-2H-pyran-4-yl acetate; decahydro-2,5,5,8a-tetramethyl-2-naphthyl acetate; 4,7-methano-3a,4,5,6,7,7a-hexahydro-5, or 6-indenyl acetate; 4,7-methano-3a,4,5,6,7,7a-hexahydro-5, or 6-indenyl propionate; 4,7-methano-3a,4,5,6,7,7a-hexahydro-5, or 6-indenyl isobutyrate; 4,7-methanooctahydro-5, or 6-indenyl acetate;

of the esters of cycloaliphatic alcohols, such as, for example, 1-cyclohexylethyl crotonate;

of the esters of cycloaliphatic carboxylic acids, such as, for example, allyl 3-cyclohexylpropionate; allyl cyclohexyloxyacetate; cis- and trans-methyldihydrojasmonate; cis- and trans-methyljasmonate; methyl 2-hexyl-3-oxocyclopentanecarboxylate; ethyl 2-ethyl-6,6-dimethyl-2-cyclohexenecarboxylate; ethyl 2,3,6,6-tetramethyl-2-cyclohexenecarboxylate; ethyl 2-methyl-1,3-dioxolan-2-acetate;

of the araliphatic alcohols, such as, for example, benzyl alcohol; 1-phenylethyl alcohol; 2-phenylethyl alcohol; 3-phenylpropanol; 2-phenylpropanol; 2-phenoxyethanol; 2,2-dimethyl-3-phenylpropanol; 2,2-dimethyl-3-(3-methylphenyl)propanol; 1,1-dimethyl-2-phenylethyl alcohol; 1,1-dimethyl-3-phenylpropanol; 1-ethyl-1-methyl-3-phenylpropanol; 2-methyl-5-phenylpentanol; 3-methyl-5-phenylpentanol; 3-phenyl-2-propen-1-ol; 4-methoxybenzyl alcohol; 1-(4-isopropylphenyl)ethanol;

of the esters of araliphatic alcohols and aliphatic carboxylic acids, such as, for example, benzyl acetate; benzyl propionate; benzyl isobutyrate; benzyl isovalerate; 2-phenylethyl acetate; 2-phenylethyl propionate; 2-phenylethyl isobutyrate; 2-phenylethyl isovalerate; 1-phenylethyl acetate; alpha-trichloromethylbenzyl acetate; alpha,alpha-dimethylphenylethyl acetate; alpha,alpha-dimethylphenylethyl butyrate; cinnamyl acetate; 2-phenoxyethyl isobutyrate; 4-methoxybenzyl acetate;

of the araliphatic ethers, such as, for example, 2-phenylethyl methyl ether; 2-phenylethyl isoamyl ether; 2-phenylethyl 1-ethoxyethyl ether; phenylacetaldehydedimethylacetal; phenylacetaldehydediethylacetal; hydratropaaldehydedimethylacetal; phenylacetaldehydeglycerinacetal; 2,4,6-trimethyl-4-phenyl-1,3-dioxane; 4,4a,5,9b-tetrahydroindeno[1,2-d]-m-dioxine; 4,4a,5,9b-tetrahydro-2,4-dimethylindeno[1,2-d]-m-dioxine;

of the aromatic and araliphatic aldehydes, such as, for example, benzaldehyde; phenylacetaldehyde; 3-phenylpropanal; hydratropaaldehyde; 4-methylbenzaldehyde; 4-methylphenylacetaldehyde; 3-(4-ethylphenyl)-2,2-dimethylpropanal; 2-methyl-3-(4-isopropylphenyl)propanal; 2-methyl-3-(4-tert.-butylphenyl)propanal; 2-methyl-3-(4-isobutylphenyl)propanal; 3-(4-tert.-butylphenyl)propanal; cinnamaldehyde; alpha-butylcinnamaldehyde; alpha-amylcinnamaldehyde; alpha-hexylcinnamaldehyde; 3-methyl-5-phenylpentanal; 4-methoxybenzaldehyde; 4-hydroxy-3-methoxybenzaldehyde; 4-hydroxy-3-ethoxybenzaldehyde; 3,4-methylenedioxybenzaldehyde; 3,4-dimethoxybenzaldehyde; 2-methyl-3-(4-methoxyphenyl)propanal; 2-methyl-3-(4-methylenedioxyphenyl)propanal;

of the aromatic and araliphatic ketones, such as, for example, acetophenone; 4-methylacetophenone; 4-methoxyacetophenone; 4-tert.-butyl-2,6-dimethylacetophenone; 4-phenyl-2-butanone; 4-(4-hydroxyphenyl)-2-butanone; 1-(2-naphthalenyl)ethanone; 2-benzofuranylethanone; (3-methyl-2-benzofuranyl)ethanone; benzophenone; 1,1,2,3,3,6-hexamethyl-5-indanyl methyl ketone; 6-tert.-butyl-1,1-dimethyl-4-indanyl methyl ketone; 1-[2,3-dihydro-1,1,2,6-tetramethyl-3-(1-methylethyl)-1H-5-indenyl]ethanone; 5′,6′,7′,8′-tetrahydro-3′,5′,5′,6′,8′,8′-hexamethyl-2-acetonaphthone;

of the aromatic and araliphatic carboxylic acids and their esters, such as, for example, benzoic acid; phenylacetic acid; methyl benzoate; ethyl benzoate; hexyl benzoate; benzyl benzoate; methylphenyl acetate; ethylphenyl acetate; geranylphenyl acetate; phenylethyl-phenyl acetate; methyl cinnamate; ethyl cinnamate; benzyl cinnamate; phenylethyl cinnamate; cinnamyl cinnamate; allylphenoxy acetate; methyl salicylate; isoamyl salicylate; hexyl salicylate; cyclohexyl salicylate; cis-3-hexenyl salicylate; benzyl salicylate; phenylethyl salicylate; methyl 2,4-dihydroxy-3,6-dimethylbenzoate; ethyl 3-phenylglycidate; ethyl 3-methyl-3-phenylglycidate;

of the nitrogen-containing aromatic compounds, such as, for example, 2,4,6-trinitro-1,3-dimethyl-5-tert.-butylbenzene; 3,5-dinitro-2,6-dimethyl-4-tert.-butylacetophenone; cinnamic acid nitrile; 3-methyl-5-phenyl-2-pentenoic acid nitrile; 3-methyl-5-phenylpentanoic acid nitrile; methyl anthranilate; methyl-N-methyl anthranilate; Schiffs bases of methyl anthranilate with 7-hydroxy-3,7-dimethyloctanal, 2-methyl-3-(4-tert.-butylphenyl)propanal or 2,4-dimethyl-3-cyclohexenecarbaldehyde; 6-isopropylquinoline; 6-isobutylquinoline; 6-sec.-butylquinoline; 2-(3-phenylpropyl)pyridine; indene; scatole; 2-methoxy-3-isopropylpyrazine; 2-isobutyl-3-methoxypyrazine;

of the phenols, phenyl ethers and phenyl esters, such as, for example, estragole; anethole; eugenol; eugenyl methyl ether; isoeugenol; isoeugenyl methyl ether; thymol; carvacrol; diphenyl ether; beta-naphthyl methyl ether; beta-naphthyl ethyl ether; beta-naphthyl isobutyl ether; 1,4-dimethoxybenzene; eugenyl acetate; 2-methoxy-4-methylphenol; 2-ethoxy-5-(1-propenyl)phenol; p-cresylphenyl acetate;

of the heterocyclic compounds, such as, for example, 2,5-dimethyl-4-hydroxy-2H-furan-3-one; 2-ethyl-4-hydroxy-5-methyl-2H-furan-3-one; 3-hydroxy-2-methyl-4H-pyran-4-one; 2-ethyl-3-hydroxy-4H-pyran-4-one;

of the lactones, such as, for example, 1,4-octanolide; 3-methyl-1,4-octanolide; 1,4-nonanolide; 1,4-decanolide; 8-decen-1,4-olide; 1,4-undecanolide; 1,4-dodecanolide; 1,5-decanolide; 1,5-dodecanolide; 4-methyl-1,4-decanolide; 1,15-pentadecanolide; cis- and trans-11-pentadecen-1,15-olide; cis- and trans-12-pentadecen-1,15-olide; 1,16-hexadecanolide; 9-hexadecen-1,16-olide; 10-oxa-1,16-hexadecanolide; 11-oxa-1,16-hexadecanolide; 12-oxa-1,16-hexadecanolide; ethylene-1,12-dodecane dioate; ethylene-1,13-tridecane dioate; coumarin; 2,3-dihydrocoumarin; octahydrocoumarin.

In perfume compositions, the amount of the alcohol according to the invention that is used is from 0.01 to 99.9 wt. %, preferably from 0.1 to 90 wt. % and particularly preferably from 0.5 to 70 wt. %, based on the total perfume oil composition.

The invention is explained in greater detail hereinbelow in an exemplary embodiment.

Perfume composition comprising 3-cyclohexenyl-1-propanol

| | |
|---|---|
| Allylcyclohexyl propionate | 3.00 |
| Amyl salicylate | 2.00 |
| Benzyl acetate | 64.00 |
| Citral 10% DPG | 2.00 |
| Citronellol inactive | 122.00 |
| Cyclamenaldehyde | 9.00 |
| Dihydromyrcenol | 3.00 |
| Dimethylbenzylcarbinyl acetate | 3.00 |
| Ethyl salicylate 10% DPG | 2.00 |
| Eugenol | 3.00 |
| Indoflor 10% DPG¹⁾ | 16.00 |
| Galaxolide 50% DEP²⁾ | 164.00 |
| Geraniol synth. | 34.00 |
| Dihydromethyl jasmonate | 6.00 |
| Heliotropin | 4.00 |
| Hexylcinnamaldehyde | 121.00 |
| 2,4-Dimethyl-3-cyclohexene-1-carbaldehyde | 3.00 |
| Hydroxycitronellal | 42.00 |
| Indole | 6.00 |
| Isobutyl salicylate | 1.00 |
| Lavender oil | 6.00 |
| Lemon oil | 2.00 |
| Acetylcedrene | 9.00 |
| Lilial³⁾ | 190.00 |
| Linalool synth. | 32.00 |
| Linalyl acetate synth. | 8.00 |
| Methyl anthranilate 10% DPG | 4.00 |
| Nerol | 8.00 |
| Orange oil | 6.00 |
| Phantolide⁴⁾ | 4.00 |
| Phenylacetaldehydedimethylacetal | 6.00 |
| Phenylethyl alcohol | 74.00 |
| Rosatol 10% DPG | 6.00 |
| Sandalwood oil | 3.00 |
| Sandranol⁵⁾ | 16.00 |
| Scatole 1% DPG | 2.00 |
| Tonalid⁶⁾ | 2.00 |
| Trifernal⁷⁾ | 2.00 |
| 3-Cyclohexenyl-1-propanol | 10.00 |
| Total | 1000.00 |

¹⁾Trade name of Symrise, Holzminden, D
²⁾Trade name of IFF, New Jersey, US
³⁾Trade name of Givaudan, Zürich, CH
^{4),6)}Trade name of PfW, Barneveld, NL
⁵⁾Trade name of Symrise, Holzminden, D
⁷⁾Trade name of Firmenich, Geneva, CH

Description of the odour of the perfume composition: flowery, lily of the valley, very natural, very soft, iris.

In the opinion of the perfumers, this fragrance composition thereby comes to life again. The impression of floweriness is considerably enhanced. 3-Cyclohexenyl-1-propanol fits into the composition well and at the same time combines the animal aspects, such as, for example, indole, with the flowery notes in an outstanding manner. It gives the composition a certain gloss, rounds it off and imparts naturalness thereto. In addition, 3-cyclohexenyl-1-propanol has a strong fixing action.

The compound 3-cyclohexenyl-1-propanol can be prepared in a manner known per se from the commercially available hydroformylation product of vinylcyclohexene. Depending on the hydroformylation conditions, the hydroformylation product may also contain the isomeric branched aldehyde (in most cases about 3-5 wt. %). The alcohol of formula 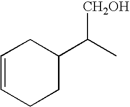
formed from the isomeric branched aldehyde by reduction has, in purified form (purity>95 wt. %), a flowery, rosy and fatty odour but, in the low percentage contents mentioned, it does not interfere with the sensory profile of the 3-cyclohexenyl-1-propanol.
Preparation of 3-cyclohexenyl-1-propanol

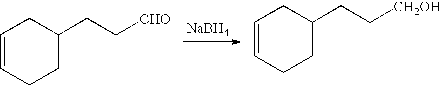

69 g (0.5 mol) of 3-cyclohexenyl-1-propanol—a commercially available hydroformylation product of vinylcyclohexene—were placed in 150 ml of methanol. A solution of 9 g (0.24 mol) of sodium borohydride and 0.094 g of 50% sodium hydroxide solution in 25 g of water was then added dropwise in such a manner that the internal temperature did not exceed 30° C. Stirring was carried out for a further 2 hours at 20° C., and the solvent was then largely removed. 20 ml of water were added to the residue, and extraction was carried out three times using 50 ml of ether each time. The combined organic phases were dried over sodium sulfate, the solvent was removed, and distillation was carried out in vacuo.

Yield: 63 g (90%) and b.p.: 105° C./5 mbar

Spectroscopic data of 3-cyclohexenyl-1-propanol:

¹H-NMR (CDCl₃, 300 MHz, TMS=0 ppm): δ=5.65 (s, 2H); 3.6 (t, 2H, J=6 Hz); 3.42 (s, 1H); 2.0-2.15 (m, 3H); 1.5-1.8 (m, 5H); 1.18-1.28 (m, 3H).

¹³C-NMR (CDCl₃, 75 MHz): δ=25.26; 28.91; 30.02; 31.86; 32.68; 33.36; 62.68; 126.22; 126.71.

MS (m/e, %): 140 (M, 10); 122 (15); 107(15); 96 (15); 94 (50); 93 (45); 81 (55); 80 (70); 79 (100); 67 (25).

1. The process of adding to a composition an amount of 3-cyclohexenyl-1-propanol as a fragrance.

2. The process according to claim 1, characterised in that 3-cyclohexenyl-1-propanol is used to impart, modify and/or enhance a cinnamon-like odour note.

3. The process according to claim 1, characterised in that 3-cyclohexenyl-1-propanol is used to impart, modify and/or enhance an odour having one or more of the notes hydrocinnamic alcohol-like, mushroom-like, hay-like, cinnamon-like, balsamic, flowery and/or an after-odour having one or more of the notes rosy, fruity, damascenone-like.

4. Fragrance composition or perfumed article comprising 3-cyclohexenyl-1-propanol.

5. Fragrance composition or perfumed article according to claim 4, comprising an amount of 3-cyclohexenyl-1-propanol that is sufficient to impart, modify and/or enhance a cinnamon-like odour note.

6. Fragrance composition or perfumed article according to claim 4, comprising an amount of 3-cyclohexenyl-1-propanol that is sufficient to impart, modify and/or enhance one or more of the odour notes hydrocinnamic alcohol-like, mushroom-like, hay-like, cinnamon-like, balsamic, flowery and/or one or more of the after-notes rosy, fruity, damascenone-like.

7. Fragrance composition according to claim 4, characterised in that the fragrance composition is a perfume oil composition and the amount of 3-cyclohexenyl-1-propanol used is from 0.01 to 99.9 wt. %, preferably from 0.1 to 90 wt. % and particularly preferably from 0.5 to 70 wt. %, based on the total perfume oil composition.

8. Process for the preparation of a fragrance composition, comprising the following step:
mixing 3-cyclohexenyl-1-propanol with conventional constituents of a fragrance composition, the 3-cyclohexenyl-1-propanol being used in an amount that is sufficient to impart, modify and/or enhance an odour note in the fragrance composition.
